(19) United States
(12) Patent Application Publication
(10) Pub. No.: US 2013/0057693 A1
(43) Pub. Date: Mar. 7, 2013

(54) INTRUDER IMAGING AND IDENTIFICATION SYSTEM

(71) Applicant: John Baranek, Hemett, CA (US)

(72) Inventor: John Baranek, Hemett, CA (US)

(21) Appl. No.: 13/562,134

(22) Filed: Jul. 30, 2012

Related U.S. Application Data
(60) Provisional application No. 61/573,224, filed on Sep. 2, 2011.

(51) Int. Cl. G06K 9/62; H04N 7/18

(52) U.S. Cl. 348/152

(57) ABSTRACT

An intruder identification system for capturing a digital image in a field of view generally comprising an image capturing device and one or a plurality of sound emitters for attracting a gaze of an intruder and a turning of their face to an image capturing position in the field of view. A preferred image capturing position being when both eyes of the intruder are viewable in the field of view of the image capturing device, detectable by the employment of facial recognition software adapted at the task and thereafter digitally storing the image. The identity of the intruder may be determined using software adapted to identify individuals from the captured facial image. The system may also employ means for electronic communication for transmitting the digital image to a video display operatively connected with a users receiving device, such as a smart phone.

This application claims priority to U.S. Provisional Application, 61/573,224, which was filed on Sep. 2, 2011, and which is incorporated herein in its entirety by reference.

### BACKGROUND OF THE INVENTION

1. Field of the Invention

The present invention relates to intruder identification systems and methods. More particularly the invention relates to an intruder identification system and method comprising a surveillance camera and means to attract the gaze of an intruder at or towards the camera in order to capture an identifiable facial image.

2. Prior Art

Video and audio surveillance is employed by business and individuals alike in order to protect themselves and their property, as well as provide peace of mind and safety for loved ones. A conventional surveillance method is to employ video capturing devices at entryways or other highly trafficked areas in order to capture video surveillance of intruders. These devices often include recording means which save captured footage for review later should a burglary or intrusion take place. The recording means is often located away from the video camera, since once discovered, an intruder will often destroy the camera in an attempt to destroy any recorded data. However, remote recording insures no data is destroyed.

In some cases the video cameras are hidden while other users choose to place the cameras in plain sight as a deterrence. Many intruders have come to realize that captured data is stored in other locations and instead of destroying the camera, will simply be dissuaded from committing the crime in the first place.

Further, facial recognition technology has been increasingly employed in surveillance systems in order to capture identifiable facial images of the intruders. These aspects can be quite advantageous to catching a perpetrator and bringing them to justice. In dim light these systems conventionally employ infrared lighting or a similar spectrum when capturing a facial image which creates a day-like environment for the surveillance cameras. Facial recognition software is additionally used in digital cameras and detect a persons facial features, such as the location of their eyes and mouth, and indicate if the person was looking into the camera and if they were smiling or not. Such facial recognition is also employed in digital photo albums to identify respective individuals.

Examples of surveillance systems in prior art include U.S. Pat. No. 7,671,890 to Wenworth teaching a roving camera system employing track system for translating the camera to better capture intruder images; US Pub. No. 2004/0117638 to Monroe teaching a method for employing facial recognition into surveillance systems.

However, a downfall of these and many other devices is that when the cameras are placed in plain sight, the intruder can simply avoid the locations of the camera as they approach a building or home. Further, even if the cameras are hidden, if the intruder is moving quickly or purposefully averting their gaze, identifiable facial images are frequently difficult to capture, even with the use of facial recognition software. Additionally, even if not hidden, the angle at which the photo is taken, will frequently only capture one side of the face, or simply not enough to provide a digital photo capable of identification by software.

US. Pub. No. 2009/0034958 A1 teaches an apparatus for attracting the gaze of a subject to be photographed. However the device requires a user to activate the gaze attracting means and is therefor not suitable for unmanned and automated surveillance systems.

As such, there is a continuing unmet need for an intruder identification system and method employment means to attract the gaze of an intruder to the line of sight of an image capturing device, such as a video camera. The device should employ facial recognition software in order to capture identifiable facial images. Such a device should advantageously employ one or a combination of an audible sound and visible light means for attracting the gaze of the subject of the photo, in a manner providing a frontal or all sides of their face, to provide sufficient digital data for software adapted to the task, to identify them.

The forgoing examples of related art and limitation related therewith are intended to be illustrative and not exclusive, and they do not imply any limitations on the invention described and claimed herein. Various limitations of the related art will become apparent to those skilled in the art upon a reading and understanding of the specification below and the accompanying drawings.

### SUMMARY OF THE INVENTION

The device herein disclosed and described provides a solution to the shortcomings in prior art and achieves the above noted goals through the provision of intruder identification system employing facial recognition software comprising a video and optionally an audio capturing and recording means and means to attract the gaze of the intruder toward the line of sight of the camera or other capturing means.

In accordance with a first preferred mode, the capturing means is provided by a video camera. As is conventionally done, the camera can be positioned at an entry way or other location of possible intrusion, such as above a window. There is preferably included a recording means, such as a data memory recorder, which is in a wired or wireless communication with the camera. It is preferred that the recorder is located and secured remotely from the camera, in the event that the intruder destroys the camera, the data will be saved and can be accessed later on. Memory cards or flash cards for storing data can also be employed for easy retrieval, and to allow a means for untrained users to communicate the captured image to third parties in a hard copy.

Means to attract the gaze of an intruder is preferably provided by one or a plurality of sound emitting components placed in various locations relative the camera, to cause the intruder or subject of the photo capture, to rotate their head horizontally and provide front and side images for capture.

In a first preferred mode, a sound emitting component is positioned at or near the location of the camera. In use when an intruder is at or near the area of surveillance, control software employing a motion detector or the like to detect the presence of an intruder, can be employed to activate the sound emitter to emit an audible sound. The sound could be one or a combination of a click, snap, crack, chirp, beep, bang, vocalization, or any other audible sound suitable for the intended purpose. At that instance, the intruder, who is often paranoid about being caught, will be distracted and reflex action will generally urge them to look towards the perceived source of the threatening sound.

With the camera capturing real time video digital images, and running facial recognition software, and with the source of the sound positioned in the line of the sight of the camera, the system can be employed so as to save power. The system will ascertain that the intruder is face forward sufficiently to render a facial image that can be captured at the instance the intruder is looking directly at the camera. The camera in this mode will only then capture the image and store it as an identifiable image which is saved. This is of great advantage over prior art where conventionally facial images are taken merely at the chance a clean face shot showing identifiable facial features is capturable, and energy is expended to run the camera and to store useless images. So in this mode, the system using software adapted to the task will take, store, and expend the energy to transmit the image and warnings, only if it is discerned that a useable image is capturable.

In another mode, a plurality of sound emitting components can be located at various location relative the camera. For example, one sound emitter can be positioned a distance to the left of the camera, and another sound emitter can be posited a distance to the right of the camera. Control software can then be employed to activate the sound emitters in sequence, such that the first sound will cause the intruder to gaze to the left of the camera, and the second sound emitter will case the intruder to rotate their gaze to the right of the camera. As such the user will horizontally sweep their gaze across the line of sight of the camera view, and both profile and face images can be captured. In addition, if the camera is hidden, the intruder will have no idea that an image has been taken, therefor reducing the chance of the camera being destroyed.

The system may include a wireless transceiver to allow the user to communicate with the system employing one or both of a cellular phone system or a router servicing a home or business using wifi or bluetooth. In a particularly preferred mode with ease of setup for the novice user, the device and images communicated therefrom, may be paired to one or more computing devices and/or network routers, based upon a unique identifier of the system such as the electronic or actual serial number, or the MacId used to identify network communications components from a single position. This will allow the user to remotely monitor or change settings of the systems while in a remote location. If the system is activated by an intruder, the user may be provided with an alert on their smart phone or other device and possibly provided with a live camera feed captured from the video capturing device.

Further, in this easy to setup mode, the user can be provided with a software application for a smartphone or other computing device having a viewable screen. The software application provides a means for the user to passively correctly set up and configure the video captured by the camera device when employing one or a plurality of sound emitters. It does so by being pre-paired to the electronic identifier of the video component and its network identifier.

It is preferred that the sound emitters and camera component are strategically positioned in a manner to attract the staring gaze or a horizontal gaze of the intruder, to thereby capture an identifiable image of an intruder. The camera device may provide a wireless communication means with the system, via wifi or bluetooth, preferably or by wired network.

To aid the user in correctly positioning the various components of the device, the software application is loaded to the smart phone or other device. It will be preprogrammed to first pair itself with the known MacId or other electronic identifier of the camera purchased by the user, based on the user-communicated serial number or other identifier. This may be done prior to providing the software using an electronic input of the identifier printed on the device or packaging, from the user, or by menu once the software application is downloaded and started. Alternatively, the software may be provided to the user with the camera identifier loaded.

The software using the internet or a local Wifi network, will pair itself to the camera or video capture device. Once paired to the video stream from the device, the video display of the smartphone, pad computer, or other networked computing device with video display, provides the user a video display of the field of view of the camera device.

Also for easy setup, the software application may also overlay in the depicted electronic video of the field of view of the camera, shown on the smartphone or other device, one or a plurality of registering lines or arrows or indicia showing the view in the line-of-sight of the camera, and the correct positioning of the various sound emitters. Also, the depicted lines shown in the video projected on the screen of the user's smart phone or computer, preferably provides means for the user to properly aim the camera, in the field of view, to alert to movement over a particular height, to thereby avoid false alarms caused by moving dogs, cats or other animals. The application overlay will project a horizontal line in the camera communicated field of view, which at a calculated distance from the camera, is a preferred horizontal height location above the walking surface. Thus, the software adapted to the task of monitoring movement will ignore movement below the line and come to alarm status on movement at or above it. This will also allow software adapted to the task, to zoom the camera image capture into the area above the line if desired for a better facial view of the intruder.

For such set up, the user would load the software on their video enabled smartphone or tablet or computing device, and pair it to the video feed from the camera either automatically, or by inputting the camera network electronic identifier. The software will only pair with a camera having the unique electronic identifier input to the software, which avoids more than one feed from neighbors cameras.

Once the software is loaded and the camera paired to the video screen seen by the user, a vertical measuring device (measuring tape, string, stick of proper height, rope, etc) is positioned a determined distance from the camera lens, such as for instance 10 feet. At that point, the software may overlay indicia on the smartphone or other video screen to be used for aiming such as a point centered in the field of view of the pre-aimed lens. From this point, one end the measuring component, is positioned on the walking surface, and the distal end is positioned at the designated amount above the walking surface, at the determined distance, in the camera's view. Once so positioned, using software to adjust the field of view, or using a manual adjustment of the camera, the aiming of the camera lens is adjusted so that the overlain horizontal aiming line on the received-video on the user's display, intersects the distal end of the vertical measuring device above the walking surface at the determined point. This software overlay, and adjustment thereto, provides a means for a height level in the field of view to be determined.

Thereafter, the camera component will initiate RF communication which may be received by the paired device or devices of the user, or the user's security company, only when there is movement above the horizontal point registered in the field of view of the camera on the walking surface. This switching is handled by software adapted to the task, and provides a means to minimize energy usage by the camera device, which is especially important if it works on batteries. It can be switched for instance, by sensing movements and changes in the pixels in the display at or above the line and save energy.

This is important because even if the batteries are charged by solar or other means, constant RF transmissions from the camera unit upon any movement, will more quickly discharge the batteries. By eliminating moment induced RF transmissions and communications of video for movements detected under a horizontal height above the ground, electrical power is greatly preserved as is the nuisance factor of constant alerts from cats, dogs, mice, blowing bushes, and other factors which move pixels in a video display and cause software to ascertain movement.

A further means to reduce the chance of false alarms, and increase electrical energy conservation may be provided through the employment of software adapted at the task of monitoring for humans who are the intruders determined to be in the field of camera view, and prior to initiating an alarm and RF or network transmissions, using onboard stored images for facial recognition software in one or two ways. First, the software can be configured to simply look to see if a discernible facial image is in the field of view of the captured scene. If it is determined to be a face, then the network communication would be initiated and use electrical power.

In a second fashion, the captured and determined human face, or in some cases an animal face, can be compared to facial images stored onboard in memory. Because the number of faces or photos for a family or small company would be very low, the amount of memory required to store them onboard the camera device is very low. Further, the computing required and energy employed by facial recognition software to determine if the image of the person in captured video of the camera's view is very low also.

Using such electronically stored authorized person images, and a software comparison thereto by software adapted to the task and running on the microprocessor engaged to the camera unit, a comparison may be made. The need for energy usage, for an RF or network transmission, and/or communication of a stream of camera imagery, is only initiated if no match of the captured image of a person's face is made, to one of those stored onboard as authorized.

Thus in both modes, the system provides a means to greatly conserve energy of batteries operating the camera and transmitters by being software-enabled and configured to minimize RF or network transmissions to times only when a human is detected above the set height line, and/or only if a face itself is determined to be in the field of view monitored, and/or only if that captured facial image is not matched to an onboard stored electronic image of an authorized human. This software enabled switching method provides a means to greatly extend battery life by limiting RF and network communications and powering up such components over the prior art which simply alerts all the time, therefor reducing required maintenance and saving energy.

It is of further advantage over prior art in that the system disclosed herein is easy to employ compared to that of existing surveillance systems. Through the employment of wireless communication, as noted, and using the downloadable or provided software, user can set up and aim the system at any desired location. This is especially important once the camera has been mounted above the reach of the user or at a position requiring a ladder. Instead of having to continually climb the ladder and move the camera, once mounted and focused at the area to be monitored, the user may simply watch the picture and overlays on their smartphone in one hand, while moving the camera unit to make the above noted aiming considerations. Help may be required for the horizontal aiming but is still rendered much easier by the overlay registration in the video screen display.

The system may employ software which self-customizes and is adapted at the task of “plug-and-play” type configurable components such that the mounting and activation of the various components can be employed with little knowledge of electronic wire or mechanical know how. Those skilled in the art will recognize the essential simplicity of the modes of operation of the device and means of employment.

Another mode of the device is envisioned that may be provided in conjunction with conventional telephone service, and which will also provide enhanced power to the system and an even easier means for initial setup. Worldwide, conventional “land line” telephone systems, employ a DC voltage which is always present on the twisted pair telephone lines. In the U.S. and in many countries, telephones have evolved so that a standardized telephone plug, will engage a socket which is attached to the twisted pair.

In a mode of the device herein, especially well adapted for use with a land-line type phone system, the camera unit has a cord or plug which is configured to engage with the conventional hard-wired phone socket. Using this connection, first, DC power may be continually provided to the camera for operations and/or charging onboard batteries. It is widely known that central wired telephone systems employ battery source power which does not get cut off in power outages on the grid. Thus even during power outages, when intrusions are much more likely to occur, the system herein has power.

Additionally, if the network modem onboard the camera unit is adapted for DSL communication, the simple plug-in of the device to a conventional phone socket, will allow it to communicate over a DSL system, either with a router in the user's home, or with a central station or the phone company itself, using either a direct DSL connection, or a connection using the DSL to the internet.

This mode of the device would be truly plug and use for unsophisticated users who would only need to plug it into the phone socket at their home or office which already exists. Onboard software would allow the device to self configure and communicate with the User's computer using a wired or wireless router, and/or with an alarm system where the electronic communications from the camera unit would be communicated using the DSL standard for the line to and from the camera.

With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present invention.

As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements.

It is an object of the system herein to provide an intruder alert system that employs cameras which communicate with user video over a network.

It is a further object of the invention, to provide such a system that minimizes power requirements to maximize battery time or allow for long term solar charging.

It is another object of the invention to employ software adapted to the task, of rendering the device easy to set up in conjunction with a smartphone or computer tablet.

Objects of the invention will be brought out in the following part of the specification, wherein detailed description is for the purpose of fully disclosing the invention without placing limitations thereon.

### BRIEF DESCRIPTION OF DRAWING FIGURES

The accompanying drawings, which are incorporated herein and form a part of the specification, illustrate some, but not the only or exclusive, examples of embodiments and/or features. It is intended that the embodiments and figures disclosed herein are to be considered illustrative rather than limiting. In the drawings:

FIG. 1 shows a preferred flow chart of the identification system.

FIG. 2 shows a schematic block diagram of a preferred mode of the present invention.

FIG. 3 shows a depiction of a particularly preferred configuration of the components of the invention.

FIG. 4 shows a depiction of another particularly preferred configuration of the components of the invention.

FIG. 5 shows a view of a video display depicting a plurality of registering lines to aid the user in configuring the system.

FIG. 6 shows another preferred flow chart of the identification system.

FIG. 7 shows yet another preferred flow chart of the identification system for comparing captured facial images with stored images to identify intruders.

### DETAILED DESCRIPTION OF THE PREFERRED EMBODIMENTS OF THE INVENTION

In this description, the directional prepositions of up, upwardly, down, downwardly, front, back, top, upper, bottom, lower, left, right and other such terms refer to the device as it is oriented and appears in the drawings and are used for convenience only; they are not intended to be limiting or to imply that the device has to be used or positioned in any particular orientation.

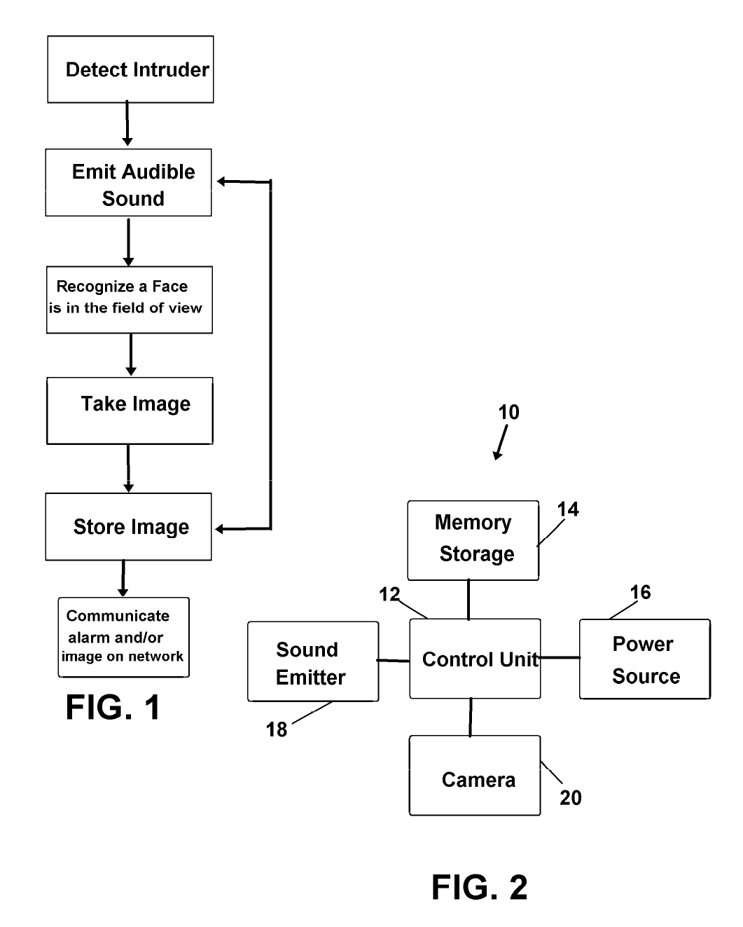

Now referring to drawings in FIGS. 1-7, wherein similar components are identified by like reference numerals, there is seen in FIG. 1 a preferred flow chart of the intruder identification system 10. In general, the invention provides a means to capture identifiable facial images of intruders by detecting the presence of the intruder, emitting an audible sound to cause the intruder to gaze in the line of sight of video capturing means, employing facial recognition software to capturing the facial image, and storing or sending the captured data to a remote location. It is noted that this invention has other applications, potentially, and one skilled in the art could discover these. The explication of the features of this invention does not limit the claims of this application; other applications developed by those skilled in the art will be included in this invention.

Video and/or audio capturing means, such as a video camera 20, can be positioned at high risk locations such as entryways 100, gates, windows, or the any other location desired by the user. In accordance with at least one preferred mode, the system 10 may be activated by motion detectors. Motion detectors may be placed at or near the area of the video camera 20 and will communicate to a power source 16 to activate the video camera 20, control unit 12, sound emitters 18, and memory storage means 14 (FIG. 2). The various components of the system 10 may be in a wired or wireless communication with the control unit 12. However a wireless communication is preferred, wherein the camera 20 and the one or plurality of sound emitters 18, 18′ have wireless transmission and reception antennas 21, 19, 19′ respectively, and additionally have individual power sources, such as solar or battery powered.

However, in other modes the system 10 may be continuously running. It is noted and anticipated that although the device is shown in its most simple form, various components and aspects of the device may be differently shaped or slightly modified when forming the invention herein. As such those skilled in the art will appreciate the descriptions and depictions set forth in this disclosure are merely meant to portray examples of preferred modes within the overall scope and intent of the invention, and are not to be considered limiting in any manner.

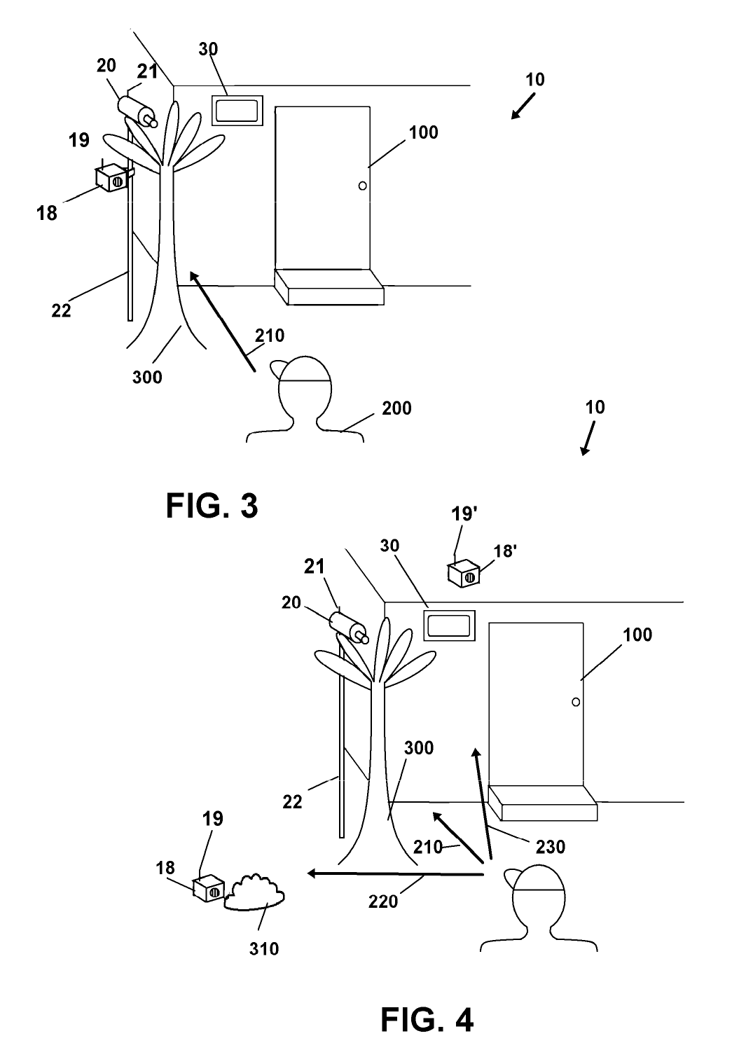

In a first preferred mode, shown in FIG. 3, a sound emitting component 18 is positioned at or substantially near the line of sight of the video camera 20. The camera 20 and sound emitter 18 may be configured on a support 22, however any suitable mounting configuration of the components of the invention can be employed, and are anticipated. Also, the camera 20 and sound emitter 18 may advantageously be hidden behind foliage 300 as to reduce the chance of the intruder 200 finding the components and destroying them.

There may also be including a light source 30, such as a flood light or infrared light. The light source 30 may be activated concurrently with the camera to ensure that the captured image is identifiable. An infrared light is preferred due to the ability to illuminate the intruder 200 in low light environments.

Once the intruder has been detected either by motion detectors or other means, the control unit 12 will run software adapted at the task of activating the sound emitter 18 then employing facial recognition software with the camera 20 to determine when or if the intruders gaze 210 is directed at the video camera 20. Again the sound emitted can be one or a combination of a click, snap, crack, chirp, beep, bang, vocalization, or any other audible sound suitable for attracting the gaze of the intruder 200 toward the source of the sound. At the instance a identifiable facial image is capture, the data is communicated to a memory storage means 14 which is preferably disposed at a remote locations.

The system 10 may repeat the process should the facial recognition software not obtain a suitable identifiable facial image. In the event that a suitable facial image is not capturable, the system 10 may then employ software adapted at the task of emitting a audible alarm from the sound emitter 18 to scare off the intruder, and optionally send a call to local authorities.

FIG. 4 shows another depiction of a particularly preferred mode of the system 10 which is configured to capture a facial view from three sides to allow for much easier identification of the captured face, and using software adapted to the task, producing a three-dimensional image of the face of the captured intruder.

In this mode of FIG. 4, the system 10 employs at least two sound emitting components 18, 18′. A first emitter 18 may be placed at distance to one side of the video camera 20 and a second emitter 18′ may be placed a distance to the opposite side of the camera 20 as shown in the figure. The emitters 18, 18′ may be hidden from view such as by foliage 310, or simply at a location out of the line of sight of the intruder. In this mode the control unit 12 employing software adapted at the task, will activate sound from the sound emitters 18, 18′ in a timed sequence.

Using two emitters activated to make a noise in a timed sequence, by activating the first emitter first in the sequence, the users gaze will be attracted in a first direction 220 towards the first emitter 18. Thereafter, by sequentially activating the second emitter 18′, at the opposite position relative to the camera, the users gaze will be attracted in a second direction 230. The positioning of the emitters 18, 18′ on opposite sides of the camera 20 will result in the intruder sweeping their gaze across the line of sight of the camera 210 and thus the system provides a means to capture a horizontally sweeping image of the face in the camera view, and facial recognition software can be adapted to capture multiple individual images and use all to ascertain an identifiable facial image. If shadows cause problems with the imaging, using software adapted to the task, because a horizontal sweep of the face has been captured, an image may be assembled with the software filling in the missing pixels at one point in the horizontal sweeping gaze, with those from another point.

It is noted that the process of sequential sound emissions may be repeated to cause the intruder 100 to sweep their gaze multiple times across the line of sight of the camera. A preferred flow chart of this mode of the invention is shown in FIG. 6. It is additionally noted that additional sound emitters may be employed to further distract the intruder away from the camera after a facial image is captured, in order to reduce the occurrence of the camera and/or emitters be found and destroyed.

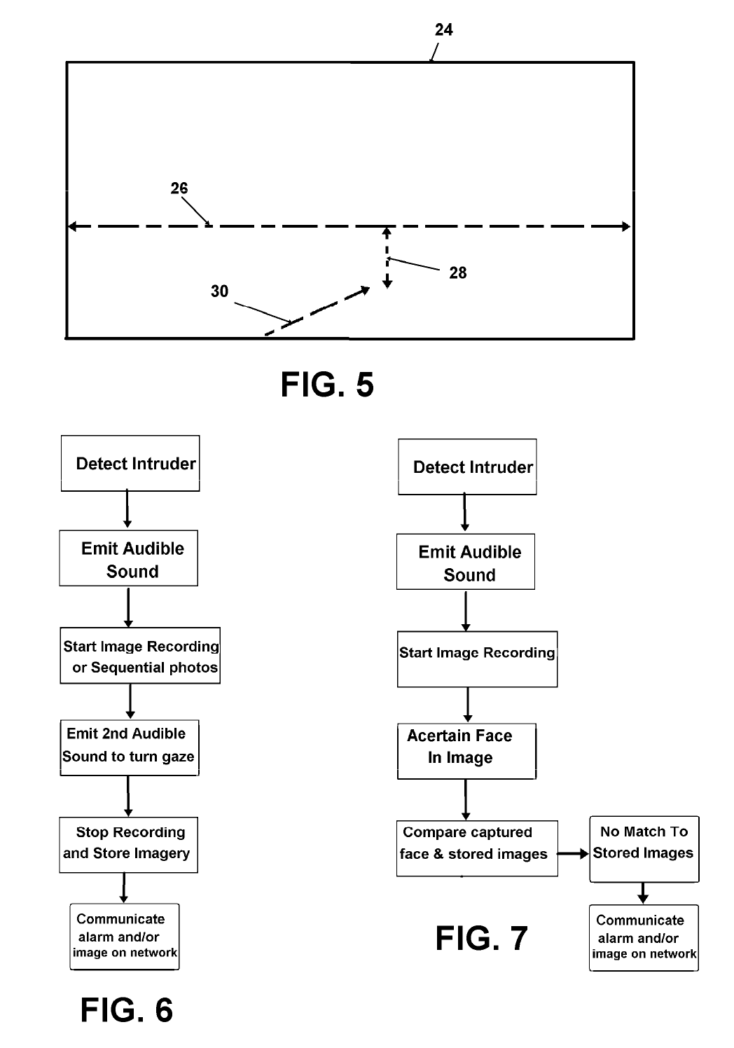

To aid the user in correctly positioning and configuring the various components of the device 10, the user may be provided with an application which can be loaded to a smart phone or other electronic device. As shown in FIG. 5, the application may provide the user with a video display 24 of the field of view of the camera 20 on their smart phone. In the display 24, there is depicted an overlay of one or a plurality of registering lines or arrows 26, 28 and showing the line-of-sight of the camera 30, and the correct positions of the various sound emitters. Also, the depicted lines 26, 28, shown in the video 24 projected on the screen of the user's smart phone or computer, preferably provides means for the user to properly aim the camera in the field of vision to alert to movement over a particular height 28, to thereby avoid false alarms caused by moving dogs, cats, and other animals. The application overlay will project a horizontal line 26 in the display 24 of the camera's communicated field of view, which at a calculated distance from the camera, is a preferred horizontal height 28 location above the walking surface. Thus, the software adapted to the task of monitoring movement will ignore movement below the line 26 and come to alarm status on movement at or above it. This will also allow software adapted to the task, to zoom the camera image into the area above the line 26 if desired for a better facial view of the intruder.

For security, the smart phone may be paired with the known MacId or other identifier of the camera 20, based on the user-communicated serial number or other identifier of the camera 20. This may be done prior to providing the software using the input from the user, or by a menu once the software application is downloaded and started.

Once paired to the video stream from the device 10, the video display of the smartphone, pad computer, or other networked computing device with video display means, provides the user a video display 24 of the field of view of the camera device.

For such set up, the user would load the software on their video enabled smartphone or tablet or computing device, and pair it to the video feed from the camera 20. The software will only pair with a camera 20 having the unique identifier input to the software which avoids more than one feed from neighbors cameras. Once the software is loaded and the camera 20 paired to the video screen seen by the user, a vertical measuring device (measuring tape, string, stick of proper height, rope, etc) may be positioned at a determined distance from the camera lens, such as for instance 10 feet. At that point, centered in the field of view of the pre-aimed lens, one end the measuring component, is positioned on the walking surface, and the distal end is positioned at the designated amount above the walking surface (registering line 28), at the determined distance, in the camera's view. Once so positioned, using software to adjust the field of view, or using a manual adjustment of the camera 20, the aiming of the camera lens is adjusted so that the overlain horizontal aiming line 26 on the received-video 24 on the user's display, intersects the distal end of the vertical measuring device above the walking surface at the determined point.

Thereafter, the camera component will initiate RF communication which may be received by the paired device or devices of the user, or the user's security company, only when there is movement above the horizontal line 26 registered in the field of view of the camera on the walking surface. This switching is handled by software adapted to the task, and provides a means to minimize energy usage by the camera device, which is especially important if it works on batteries. This is because even if the batteries are charged by solar or other means, constant RF transmissions from the camera unit on any movement, will more quickly discharge the batteries. By eliminating moment induced RF transmissions and communications of video for movements detected under a horizontal height 26 above the ground, electrical power is greatly preserved as is the nuisance factor of constant alerts from cats, dogs, mice, blowing bushes, and other factors which move pixels in a video display and cause software to ascertain movement.

A further means to reduce the chance of false alarms, and increase electrical energy conservation may be provided through the employment of software adapted at the task of monitoring for humans who are the intruders determined to be in the field of camera view, and prior to initiating an alarm and RF or network transmissions, using onboard stored images for facial recognition software in one or two ways. First, the software can be configured to simply look to see if a discernible facial image is in the field of view of the captured scene. If it is determined to be a face, then, the network communication would be initiated and use electrical power.

In a second fashion shown in the flow chart of FIG. 7, the captured and determined human face, or in some cases an animal face, can be compared to facial images stored onboard in memory. Because the number of faces or photos for a family or small company would be very low, the amount of memory required to store them onboard the camera device is very low. Further, the computing required and energy employed by facial recognition software to determine if the image of the person in captured video of the camera's view is very low also.

Using such electronically stored authorized person images, and a software comparison thereto by software adapted to the task and running on the microprocessor engaged to the camera unit, a comparison may be made. The need for energy usage, for an RF or network transmission, and/or communication of a stream of camera imagery, is only initiated if no match of the captured image of a person's face is made, to one of those stored onboard as authorized.

While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention as defined by the following claims.

What is claimed:

1. An intruder identification system comprising;
means for capturing a digital image of a field of view;
a sound emitter, said sound emitter providing means to attract a gaze of an intruder and a turning of their face to an image capturing position, wherein both eyes of said intruder are viewable in said field of view; and
means to capture a facial image of said intruder while in said image capturing position;
means to digitally store said facial image; and
whereby an intruder viewable within said field of view is induced to turn their head to said image capturing position by said means to produce a sound, whereafter an identity of said intruder may be determined using software adapted to identify individuals from said facial image.

2. The intruder identification system of claim 1 wherein said means for attracting the gaze of an intruder comprises;
a plurality of sound emitters, a first of said sound emitters positioned adjacent to a first side of said field of view;
a second of said sound emitters positioned adjacent to an opposite side of said field of view;
means to sequentially activate each respective sound emitter to emit sequential sounds;
a first of said sounds attracting said gaze of said intruder toward said first side of said field of view;
a second of said sounds attracting said gaze of said intruder toward said opposite side;
said facial image being a series of said facial images taken between a time of said first sound and said second sound; and
said facial image captured being a panoramic said facial image.

3. The intruder identification system of claim 1 wherein means to capture said digital image of a field of view, comprises:
a digital camera, said digital camera communicating a digital image reproducible upon a video screen, said digital image comprising all or portions of said field of view.

4. The intruder identification system of claim 2 wherein means to capture said digital image of a field of view, comprises:
a digital camera, said digital camera communicating a digital image reproducible upon a video screen, said digital image comprising all or portions of said field of view.

5. The intruder identification system of claim 3 additionally comprising:
means for electronic communication of said digital image over a network;
said means for electronic communication having an electronic identifier;
said electronic identifier providing means to pair said means for electronic communication to a receiving device in communication with said network;
said means for electronic communication transmitting said digital image to a video display operatively connected with said receiving device; and
whereby said field of view or said portions thereof including said facial image is viewable at a remote location upon said digital display.

6. The intruder identification system of claim 4 additionally comprising:
means for electronic communication of said digital image over a network;
said means for electronic communication having an electronic identifier;
said electronic identifier providing means to pair said means for electronic communication to a receiving device in communication with said network;
said means for electronic communication transmitting said digital image to a video display operatively connected with said receiving device; and
whereby said field of view or said portions thereof including said facial image is viewable at a remote location upon said digital display.

7. The intruder identification system of claim 5 additionally comprising:
said intruder identification system employing battery power for operation thereof;
control software running on a microprocessor, said control software configured to determine if a said facial image has been captured by said digital camera; an
said control software energizing said means for electronic communication over said network to operate, only upon a determination said facial image has been captured, thereby providing means to conserve said battery power by a minimizing of employment of said means for electronic communication over said network.

8. The intruder identification system of claim 6 additionally comprising:
said intruder identification system employing battery power for operation thereof;
control software running on a microprocessor, said control software configured to determine if a said facial image has been captured by said digital camera; an
said control software energizing said means for electronic communication over said network to operate, only upon a determination said facial image has been captured, thereby providing means to conserve said battery power by a minimizing of employment of said means for electronic communication over said network.

9. The intruder identification system of claim 5 additionally comprising electronic means for aiming, comprising:
communicating indicia to said video display operatively connected with said receiving device;
said indicia superimposing aiming lines upon a said digital image of said field of view; and
said lines providing means to aim said digital camera while viewing said video display.

10. The intruder identification system of claim 6 additionally comprising electronic means for aiming, comprising:
communicating indicia to said video display operatively connected with said receiving device;
said indicia superimposing aiming lines upon a said digital image of said field of view; and
said lines providing means to aim said digital camera while viewing said video display.

11. The intruder identification system of claim 9 additionally comprising:
software adapted to monitor pixels in said field of view and activate said digital camera to capture images of said field of view if movement of said pixels is determined; and
said lines defining portions of said field of view where said moment in said pixels is ignored.

12. The intruder identification system of claim 10 additionally comprising:
software adapted to monitor pixels in said field of view and activate said digital camera to capture images of said field of view if movement of said pixels is determined; and
said lines defining portions of said field of view where said moment in said pixels is ignored.

13. A method for capturing digital identifiable facial images of an intruder employing a intruder identification system comprising intruder detection means, means for capturing a digital image of a field of view, means for attracting the gaze of an intruder toward a line of sight extending forward of said means for capturing a digital image, means to capture a facial image of said intruder during said gaze, and a data storage means, comprising the steps of;
employing said intruder detection means to detect an intruder entering said field of view;
employing said means for attracting said gaze of said intruder while in said field of view;
capturing a said facial image within said field of view, during said gaze; and
storing said captured image in a remote data storage location remote to said means for capturing said digital image as a means to prevent destruction thereof by said intruder.
